(19) United States
(12) Patent Application Publication
(10) Pub. No.: US 2005/0280861 A1
(43) Pub. Date: Dec. 22, 2005

(54) Distributed printing control apparatus and print job distribution method

(75) Inventors: Toshihiro Shima, Nagano-ken (JP); Shinya Taniguchi, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/114,228

(22) Filed: Apr. 26, 2005

(30) Foreign Application Priority Data
Apr. 27, 2004 (JP) 2004-130822

(51) Int. Cl. G06F 15/00

(52) U.S. Cl. 358/1.15

(57) ABSTRACT

A distributed printing control apparatus of the invention includes a storage module that stores identification information for identifying at least a previous distribution destination printing device, and a control module. On reception of a print job sent under a preset condition, the control module specifies a current distribution destination printing device based on the identification information, among residual printing devices other than the previous distribution destination printing device, sends the received print job to the specified current distribution destination printing device, and stores information for identifying the specified current distribution destination printing device as the identification information into the storage module. The technique of the invention distributes multiple print jobs to multiple printing devices under the policy of restricting specification of an identical printing device for consecutive distribution of sequential print jobs. This arrangement desirably prevents inefficient concentration of print jobs on one particular printing device and completes printing in a short time period.

### BACKGROUND OF THE INVENTION

1. Field of the Invention

The present invention relates to a technique of distributing print jobs to two or more printing devices connected to a network to attain distributed printing. More specifically the technique of the invention restricts specification of an identical printer for consecutive distribution of sequential print jobs.

2. Description of the Related Art

A printing system including multiple printers connected to an identical network has been widespread to enable each user to selectively use the multiple printers. A distributed printing technique has been proposed to distribute multiple print jobs to multiple printers for parallel printing and thereby complete printing in a short time period (see, for example, Japanese Patent Laid-Open Gazette No. 2002-215368).

In the prior art printing system that distributes multiple print jobs to multiple printers, the printer specified as the previous distribution destination printer may be consecutively selected for distribution of a current print job, while there are other printers that have not been specified as the distribution destination for some time. This undesirably concentrates print jobs on one particular printer and extends the total processing time to complete printing.

### SUMMARY OF THE INVENTION

The object of the present invention is thus to restrict specification of an identical printing device for consecutive distribution of sequential print jobs, thus preventing inefficient concentration of print jobs on one particular printing device and completing printing in a short time period.

In order to attain at least part of the above and the other related objects, the present invention is directed to a distributed printing control apparatus that distributes multiple print jobs sent via a network to at least two printing devices among multiple printing devices connected to the network. The distributed printing control apparatus includes: a storage module that stores identification information for identifying at least a previous distribution destination printing device among the multiple printing devices; and a control module. On reception of a print job sent under a preset condition, the control module specifies a current distribution destination printing device based on the identification information, among residual printing devices other than the previous distribution destination printing device, sends the received print job to the specified current distribution destination printing device, and stores information for identifying the specified current distribution destination printing device as the identification information into the storage module.

The distributed printing control apparatus of the invention stores the identification information for identifying the previous distribution destination printing device. The technique of the invention refers to the identification information and avoids specification of the previous distribution destination printing device as the current distribution destination printing device. This arrangement effectively prevents concentration of print jobs on one particular printing device and thus completes printing in a short time period.

In one preferable embodiment of the distributed printing control apparatus of the invention, the storage module stores sequence information representing a predetermined sequence of the multiple printing devices. The control module selects a printing device with a next ordinal number subsequent to an ordinal number of the previous distribution destination printing device, based on the identification information and the sequence information, and specifies the selected printing device as the current distribution destination printing device.

The distributed printing control apparatus of this embodiment stores the sequence information representing the predetermined sequence of the multiple printing devices. The technique of this embodiment refers to this sequence information and the identification information and specifies the printing device with the next ordinal number subsequent to the ordinal number of the previous distribution destination printing device as the current distribution destination printing device. The previous distribution destination printing device is thus placed at the end of the predetermined sequence. This arrangement enables the printing device that has not been selected for distribution of the print job for the longest time period to be specified as the current distribution destination printing device. The print job is thus distributed to the printing device having the high potential for starting execution of the print job at the earlier timing. This desirably ensures completion of printing in a short time period.

The multiple printing devices are specified as the distribution destination in the predetermined sequence. This arrangement enables the substantially identical number of print jobs to be distributed to the respective printing devices. This effectively prevents concentration of print jobs on one particular printing device and thus ensures completion of printing in a short time period.

In another preferable embodiment of the distributed printing control apparatus of the invention, the control module extracts at least online printing devices as possible options for a distribution destination printing device among the multiple printing devices, and specifies the current distribution destination printing device among the extracted possible options other than the previous distribution destination printing device, based on the identification information.

This arrangement effectively excludes offline and unavailable printing devices with some errors, for example, an out-of-paper error, from the extracted possible options for the distribution destination printing device, thus ensuring completion of printing in a short time period.

In still another preferable embodiment of the distributed printing control apparatus of the invention, the storage module stores sequence information representing a predetermined sequence of the multiple printing devices. The control module extracts at least online printing devices as possible options for a distribution destination printing device among the multiple printing devices, refers to the identification information and the sequence information to sequentially retrieve a printing device that has a next ordinal number subsequent to an ordinal number of the previous distribution destination printing device and is included in the extracted possible options, and specifies a first retrieved printing device as the current distribution destination printing device.

The printing device included in the extracted possible options is retrieved, based on the identification information and the sequence information representing the predetermined sequence of the multiple printing devices. The retrieval starts from the printing device having a next ordinal number subsequent to the ordinal number of the previous distribution destination printing device and is performed in the predetermined sequence represented by the sequence information. The first retrieved printing device to be included in the extracted possible options is specified as the current distribution destination printing device. This arrangement effectively excludes offline and unavailable printing devices with some errors, for example, an out-of-paper error, from the extracted possible options for the distribution destination printing device. This arrangement also enables the printing device that has not been selected for distribution of the print job for the longest time period to be specified as the current distribution destination printing device. The print job is thus distributed to the printing device having the high potential for starting execution of the print job at the earlier timing. This desirably ensures completion of printing in a short time period.

In the distributed printing control apparatus of the invention, the print job sent under the preset condition may be at least one of a print job sent with a specific port number, a print job sent in a specific printing protocol, a print job sent by a specific command on a printing protocol, and a print job sent in a format including a specific print command.

This structure does not require installation of any special software program in the computer but attains distributed printing by simply changing the port number included in the print job to the specific port number, by simply changing the printing protocol to the specific printing protocol, by simply changing the command on the printing protocol to the specific command, or by simply changing the print command included in the print job to the specific print command, prior to transmission of the print job from the computer to the distributed printing control apparatus. This arrangement significantly saves the user's time and labor.

In one preferable structure of the distributed printing control apparatus of the invention, the print job sent under the preset condition is a print job sent with a specific port number. In this structure, the control module sends the print job with a different port number from the particular port number to the current distribution destination printing device.

This structure does not require installation of any special software program in the computer but attains distributed printing by simply changing the port number included in the print job to the specific port number prior to transmission of the print job from the computer to the distributed printing control apparatus. This arrangement significantly saves the user's time and labor. When the distributed printing control apparatus is built in a particular printing device and the particular printing device is specified as one of the distribution destination printing devices, the print job distributed to the particular printing device includes the different port number from the specific port number. This arrangement clearly discriminates the distributed print job from the print job sent with the specific port number, thus preventing endless redistribution of the same print job.

In another preferable structure of the distributed printing control apparatus of the invention, the print job sent under the preset condition is a print job sent in a specific printing protocol. In this structure, the control module sends the print job in a different printing protocol from the specific printing protocol to the current distribution destination printing device.

This structure does not require installation of any special software program in the computer but attains distributed printing by simply changing the printing protocol to the specific printing protocol prior to transmission of the print job from the computer to the distributed printing control apparatus. This arrangement significantly saves the user's time and labor. When the distributed printing control apparatus is built in a particular printing device and the particular printing device is specified as one of the distribution destination printing devices, the print job distributed to the particular printing device uses the different printing protocol from the specific printing protocol. This arrangement clearly discriminates the distributed print job from the print job sent in the specific printing protocol, thus preventing endless redistribution of the same print job.

In still another preferable structure of the distributed printing control apparatus of the invention, the print job sent under the preset condition is a print job sent by a specific command on a printing protocol. In this structure, the control module sends the print job by a different command on the printing protocol from the specific command to the current distribution destination printing device.

This structure does not require installation of any special software program in the computer but attains distributed printing by simply changing the command on the printing protocol to the specific command prior to transmission of the print job from the computer to the distributed printing control apparatus. This arrangement significantly saves the user's time and labor. When the distributed printing control apparatus is built in a particular printing device and the particular printing device is specified as one of the distribution destination printing devices, the print job distributed to the particular printing device uses the different command from the specific command. This arrangement clearly discriminates the distributed print job from the print job sent by the specific command on the printing protocol, thus preventing endless redistribution of the same print job.

In another preferable structure of the distributed printing control apparatus of the invention, the print job sent under the preset condition is a print job sent in a format including a specific print command. In this structure, the control module sends the print job including a different print command from the specific print command to the current distribution destination printing device.

This structure does not require installation of any special software program in the computer but attains distributed printing by simply changing the print command included in the print job to the specific print command prior to transmission of the print job from the computer to the distributed printing control apparatus. This arrangement significantly saves the user's time and labor. When the distributed printing control apparatus is built in a particular printing device and the particular printing device is specified as one of the distribution destination printing devices, the print job distributed to the particular printing device includes the different print command from the specific print command. This arrangement clearly discriminates the distributed print job from the print job sent in the format including the specific print command, thus preventing endless redistribution of the same print job.

The distributed printing control apparatus may be built in or connected to at least one particular printing device among the multiple printing devices connected to the network.

In one preferable embodiment of the distributed printing control apparatus built in or connected to the particular printing device, the control module is allowed to specify the particular printing device as the current distribution destination printing device.

This arrangement enables the particular printing device to be extractable as one of the possible options for the distribution destination printing device, thus desirably expanding the selectable range for the distribution destination printing device.

In another preferable embodiment of the distributed printing control apparatus built in or connected to the particular printing device, the control device extracts printing devices of an identical model with the particular printing device among the multiple printing devices and specifies the current distribution destination printing device among the extracted printing devices of the identical model.

In this embodiment, the distributed printing control apparatus built in or connected to the particular printing device receives the print job sent for the particular printing device. Specification of the printing device of the identical model with the particular printing device as the current distribution destination printing device enables the current distribution destination printing device to perform an adequate printing operation without any data conversion of the received print job.

In one preferable structure of the distributed printing control apparatus built in or connected to the particular printing device, the storage module stores a distribution destination specification file. The control module refers to contents of the distribution destination specification file and extracts the printing devices of the identical model with the particular printing device.

The distribution destination specification file enables the possible options for the distribution destination printing device to be narrowed to the desired printing devices.

The present invention is not restricted to the distributed printing control apparatus having any of the above arrangements, but is also actualized by diversity of other applications, for example, a printing device including the built-in distributed printing control apparatus and a corresponding print job distribution method. Other possible applications include a computer program that is used to attain the method or the apparatus, a recording medium in which such a computer program is recorded, and a data signal that includes such a computer program and is embodied in a carrier wave.

In the applications of the invention as the computer program and the recording medium in which the computer program is recorded, the invention may be given as a whole program to control the printing device or as a partial program to exert only the characteristic functions of the invention. Available examples of the recording medium include flexible disks, CD-ROMs, DVD-ROMs, magneto-optical disks, IC cards, ROM cartridges, punched cards, prints with barcodes or other codes printed thereon, internal storage devices (memories like RAMs and ROMs) and external storage devices of the computer, and diversity of other computer readable media.

### BRIEF DESCRIPTION OF THE DRAWINGS

FIG. 1 schematically illustrates the configuration of a printing system including a printer PRT1 in a first embodiment of the invention;

FIG. 2 conceptually shows the structure of communication data including a print job;

FIG. 3 mainly shows the structure of the printer PRT1 included in the printing system of FIG. 1;

FIGS. 4(A) through 4(C) show an example of homepage for the user's specification of desired printers for a distribution destination printer, which is open on a browser window BW of a terminal;

FIG. 5 conceptually shows a sequence of the desired printers for the distribution destination printer specified in a distribution destination specification file Fa;

FIG. 6 is a flowchart showing a parent task processing routine executed in the printer PRT1;

FIG. 7 is a flowchart showing a child task processing routine executed in the printer PRT1;

FIG. 8 is a flowchart showing the details of a distribution destination printer specification process executed by a parent task processing module 23;

FIGS. 9(A) and 9(B) conceptually show an example of specification of the distribution destination printers; and

FIG. 10 mainly shows a modified structure of the printer PRT1 in a second embodiment of the invention.

### DESCRIPTION OF THE PREFERRED EMBODIMENTS

Some modes of carrying out the invention are described below as preferred embodiments in the following sequence:

A. First Embodiment

A1. System Configuration
A2. Structure of Printer
A3. General Printing Process
A4. Distributed Printing Process
A5. Effects of Embodiment
   B. Second Embodiment
B1. Structure of Printer
B2. General Printing Process
B3. Distributed Printing Process
B4. Effects of Embodiment
   C. Modifications
C1. Modified Example 1—
C12. Modified Example 12

### A. First Embodiment

### A1. System Configuration

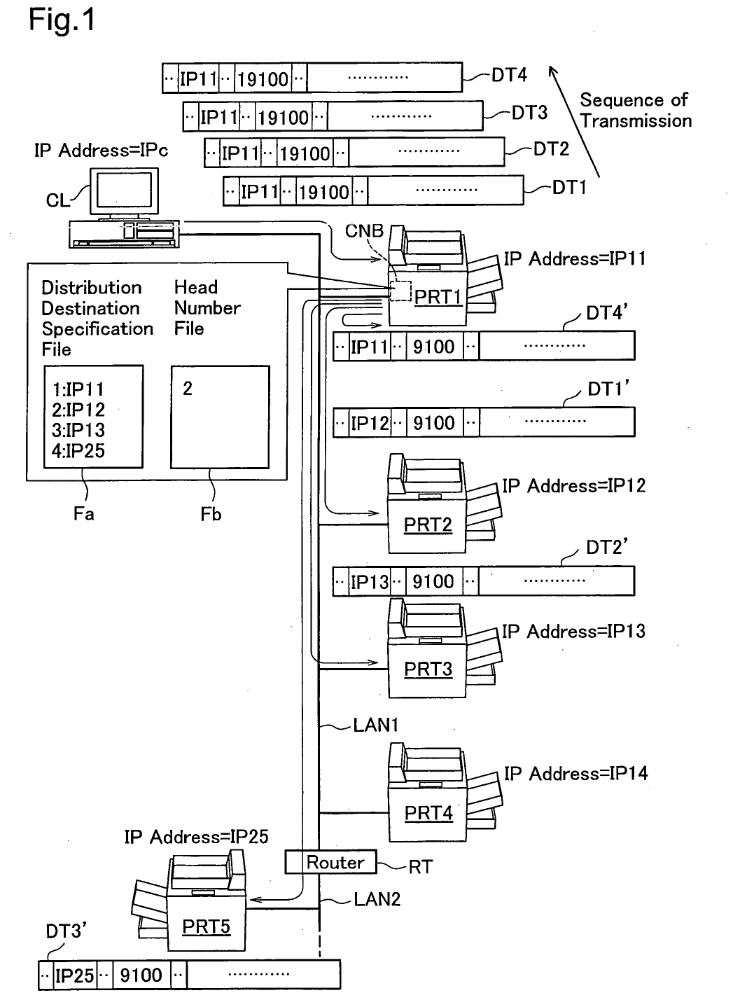

FIG. 1 schematically illustrates the configuration of a printing system including a printer PRT1 in a first embodiment of the invention. As illustrated, this printing system includes a client PC (hereafter referred to as the client) CL and multiple printers PRT1 to PRT5. The client CL and the printers PRT1 to PRT4 are connected to one local area network LAN1, and the printer PRT5 is connected to another local area network LAN2. The two local area networks LAN1 and LAN2 are interconnected via a router RT.

Communication between the respective devices basically follows the TCP/IP protocol, and fixed IP addresses are allocated to the respective devices. For convenience of explanation, it is assumed that fixed IP addresses ‘IPc’, ‘IP11’ to ‘IP14’, and ‘IP25’ are respectively allocated to the client CL, to the printers PRT1 to PRT4, and to the printer PRT5. Strictly speaking, these IP addresses are not set directly in the client CL or the printers PRT1 to PRT5, but are set at corresponding TCP/IP nodes in the network (for example, network boards connected to the network for TCP/IP communication).

Among these printers, the printer PRT1 is equipped with a custom network board CNB. The custom network board CNB has distributed printing control functions to distribute received print jobs to other printers and implement distributed printing, and is equivalent to the distributed printing control apparatus of the invention. Standard network boards (not shown) are attached to the other printers.

In the illustrated example of FIG. 1, multiple communication data DT1 to DT4 are sent in this sequence from the client CL to the printer PRT1. These communication data DT1 to DT4 respectively include different print jobs.

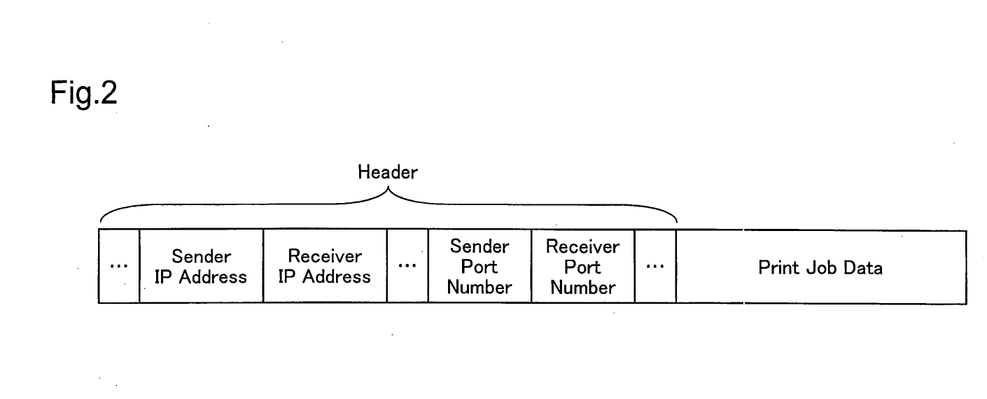

FIG. 2 conceptually shows the structure of communication data including a print job. As shown in FIG. 2, the communication data is mainly divided into a header and print job data.

The header includes an IP address allocated to a sender device as a sender of the communication data (sender IP address), a port number for specifying the software program of the sender in the sender device (sender port number), an IP address allocated to a receiver device as a receiver of the communication data (receiver IP address), and a port number for specifying the software program of the receiver in the receiver device (receiver port number). The communication data transmitted from the software program in the sender device is sent to the receiver device having the specified receiver IP address. The receiver device receives the communication data and transfers the print job data included in the received communication data to the software program standing by at a port having the specified receiver port number.

The TCP/IP protocol generally transmits communication data in the form of packets. In the actual transmission, series of print job data are time-shared and are sent as multiple time-shared data with the identical header.

Referring back to FIG. 1, the communication data DT1 includes ‘IP11’ as the receiver IP address and ‘19100’ as the receiver port number.

The printing protocol adopted in this embodiment is a non-procedural protocol, which a port number ‘9100’ is generally allocated to. The system of this embodiment, however, uses a particular port number ‘19100’, instead of the general port number ‘9100’, to send print jobs from the client CL to the printer PRT1 having the distributed printing control functions.

On the custom network board CNB in the printer PRT1 of the embodiment, a distributed printing software program stands by at the port ‘19100’ to attain the distributed printing control functions. In response to a connection from the client CL to send the communication data DT1, a functional module actualized by a CPU executes the distributed printing software program to read a distribution destination specification file Fa, make an inquiry about the model name to all the devices with IP addresses specified in the distribution destination specification file Fa, and extract all online printers of an identical model with the printer PR1.

The functional module then reads a head number file Fb and determines whether the extracted printers include a target printer with a certain IP address corresponding to an ordinal number written in the head number file Fb. When the target printer is included in the extracted printers, the target printer is specified as a distribution destination printer. The functional module overwrites the head number file Fb with a next ordinal number subsequent to the ordinal number of the specified distribution destination printer.

In the illustrated example of FIG. 1, all the printers PRT1 to PRT3 and PRT5 specified in the distribution destination specification file Fa are extracted as the online printers of the identical model with the printer PR1. The extracted printers include the printer PRT2 with the IP address ‘IP12’ corresponding to an ordinal number ‘2’ written in the head number file Fb. The printer PRT2 is accordingly specified as the distribution destination printer. The head number file Fb is then overwritten with a next ordinal number ‘3’ of the printer PRT3 subsequent to the ordinal number ‘2’ of the specified printer PRT2.

The functional module changes the receiver port number from ‘19100’ to ‘9100’ in the received communication data DT1 and sends communication data DT1′ including a print job to the printer PRT2 specified as the distribution destination printer. The communication data DT1′ include the receiver IP address ‘IP12’ and the changed receiver port number ‘9100’.

The standard network board attached to the printer PRT2 receives the communication data DT1′ and transfers the print job data to a software program standing by at the port ‘9100’. The port number ‘9100’ is generally allocated to the non-procedural protocol adopted as the printing protocol in this embodiment as mentioned previously. A print control software program installed in the printer PRT2 receives the print job data and performs a printing operation according to the received print job data.

The functional module in the printer PRT1 restarts the specification process of the distribution destination printer described above, in response to another connection from the client CL for transmission of the next communication data DT2, after the head number file Fb is overwritten with the ordinal number ‘3’. The head number file Fb currently has the ordinal number ‘3’. When the extracted online printers of the identical model with the printer PRT1 include the printer PRT3 with the IP address corresponding to the ordinal number ‘3’, the printer PRT3 is specified as the distribution destination printer. This time the functional module sends communication data DT2′ including the receiver IP address ‘IP13’ and the receiver port number ‘9100’ to the specified printer PRT3.

Similarly the functional module specifies the distribution destination printers for the subsequently received communication data DT3 and DT4. When the extracted online printers of the identical model with the printer PRT1 include the printer PRT5 and include the printer PRT1, the functional module specifies the printer PRT5 and the printer PRT1 as the distribution destination printer and sends communication data DT3′ and communication data DT4′ to the specified printer PRT5 and to the specified printer PRT1 as shown in FIG. 1.

The printing system of the embodiment distributes multiple print jobs to multiple printers under the policy of restricting specification of an identical printer for consecutive distribution of sequential print jobs.

### A2. Structure of Printer

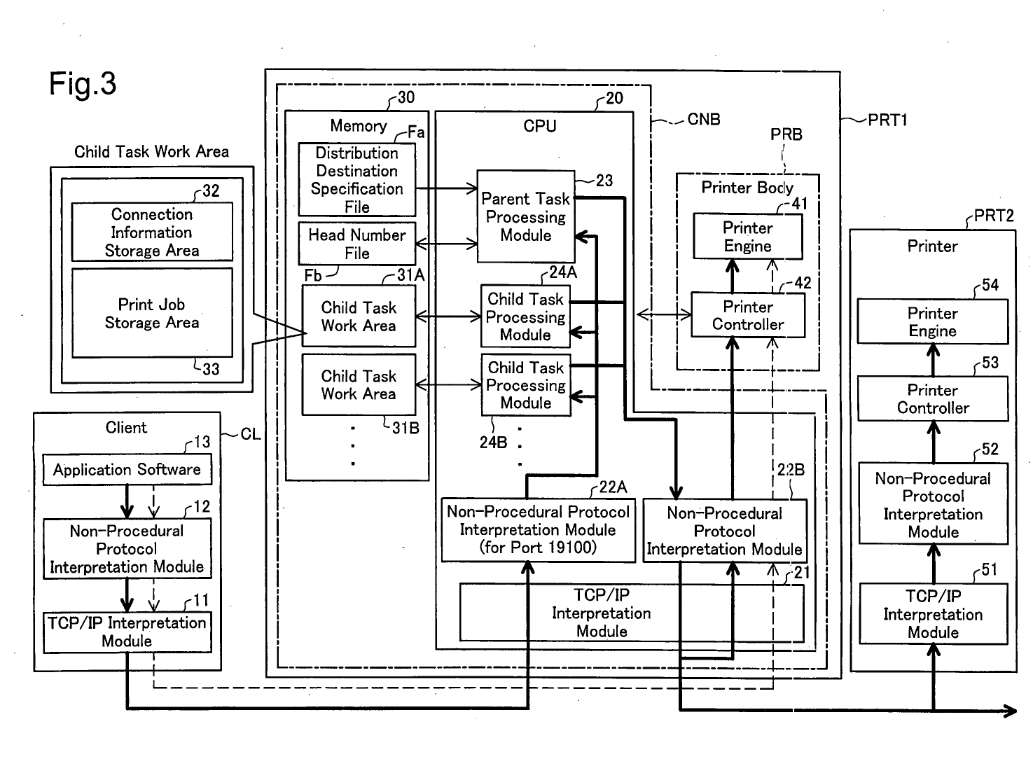

FIG. 3 mainly shows the structure of the printer PRT1 included in the printing system of FIG. 1. The printer PRT1 has a printer body PRB and the custom network board CNB described above. The printer body PRB mainly includes a printer engine 41 and a printer controller 42. The printer engine 41 is a mechanism driven to actually implement printing. The printer controller 42 receives print job data from the custom network board CNB and controls the printer engine 41 to perform a printing operation according to the received print job data.

The custom network board CNB mainly includes a CPU 20 and a memory 30. Other elements of the custom network board CNB including a communication interface that takes charge of network communication are omitted from the illustration for simplicity of explanation.

The CPU 20 reads the distributed printing software program and other relevant programs from the memory 30 and executes the programs to work as respective functional blocks illustrated in FIG. 3. These functional blocks may be actualized by the hardware configuration, instead of the software configuration. This CPU 20 is equivalent to the control module of the invention.

Among the functional blocks, a TCP/IP interpretation module 21 interprets the TCP/IP protocol and establishes external communication via the network. The TCP/IP interpretation module 21 detects the receiver IP address and the receiver port number included in received communication data, while setting the receiver IP address and the receiver port number in communication data to be transmitted. Non-procedural protocol interpretation modules 22A and 22B interpret the non-procedural protocol adopted as the printing protocol. In the structure of this embodiment, for convenience of explanation, it is assumed that the non-procedural protocol interpretation module 22B is activated when the communication data include the general number ‘9100’ set to the receiver port number and that the non-procedural protocol interpretation module 22A is activated when the communication data include the particular number ‘19100’ set to the receiver port number.

A parent task processing module 23 executes parent task to specify a distribution destination printer and generate a child task processing module as described later. The generated child task processing module executes child task to transfer a print job received from the client CL to the specified distribution destination printer. No child task processing modules exist in the initial state. The parent task processing module 23 generates one child task processing module in response to each connection from the client CL. Two child task processing modules 24A and 24B are generated in the illustrated example of FIG. 3.

The memory 30 stores the programs including the distributed printing software program, as well as various data including the distribution destination specification file Fa and the head number file Fb. A child task work area is set in the memory 30 corresponding to generation of each child task processing module. The child task work area is used for execution of the child task by the corresponding child task processing module. In the illustrated example of FIG. 3, two child task work areas 31A and 31B are set in the memory 30 corresponding to the two child task processing modules 24A and 24B.

The child task work area includes a connection information storage area 32 and a print job storage area 33. The connection information storage area 32 stores the IP address of a specified distribution destination printer, and the print job storage area 33 temporarily stores a print job received from the client CL. The child task work area is freed from the setting when the corresponding child task processing module completes the child task and is deleted.

As illustrated in FIG. 3, the client CL includes a TCP/IP interpretation module 11 and a non-procedural protocol interpretation module 12 as functional blocks, in addition to application software 13. The printer PRT2 includes a TCP/IP interpretation module 51 and a non-procedural protocol interpretation module 52 as functional blocks, as well as a printer controller 53 and a printer engine 54. The non-procedural protocol interpretation module 12 of the client CL and the non-procedural protocol interpretation module 52 of the printer PRT2 have the same functions as those of the non-procedural protocol interpretation module 22B of the printer PRT1 that deals with the communication data sent with the general number ‘9100’ set to the receiver port number. The TCP/IP interpretation module 11 of the client CL and the TCP/IP interpretation module 51 of the printer PRT2 have the same functions as those of the TCP/IP interpretation module 21 of the printer PRT1. The printer controller 53 and the printer engine 54 of the printer PRT2 have the same functions as those of the printer controller 42 and the printer engine 41 of the printer PRT1. The printer PRT2 has a non-illustrated memory and is designed to receive another print job even during execution of one print job and store the newly received print job in the memory.

### A3. General Printing Process

A general printing process is described briefly, prior to description of a distributed printing process. In an example of the general printing process, a print job is sent from the client CL to the printer PRT1 and is executed by only the printer PRT1. In this case, the print job is transferred along a route shown by the dotted arrows in FIG. 3. The printing protocol is set to the non-procedural protocol in a printer driver (not shown) of the client CL.

In response to the user's print command given to the client CL, the application software 13 installed in the client CL sends a print job via the non-procedural protocol interpretation module 12 and the TCP/IP interpretation module 11 to the printer PRT1. The non-procedural protocol interpretation module 12 sends communication data including the print job according to the non-procedural printing protocol. The TCP/IP interpretation module 11 specifies ‘IP11’ allocated to the printer PRT1 as the receiver IP address of the communication data and ‘9100’ generally allocated to the non-procedural protocol as the receiver port number of the communication data.

The TCP/IP interpretation module 21 of the printer PRT1 specified by the receiver IP address ‘IP11’ included in the communication data receives the communication data and transfers the received communication data to the non-procedural protocol interpretation module 22B specified by the receiver port number ‘9100’ included in the received communication data. The non-procedural protocol interpretation module 22B receives the communication data including the print job and transfers the print job to the printer controller 42 according to the non-procedural protocol. The printer controller 42 controls the printer engine 41 to perform a printing operation specified by the received print job.

### A4. Distributed Printing Process

The distributed printing process is described in detail. When the user turns on power of the printer PRT1, the printer body PRB and the custom network board CNB are activated. The parent task processing module 23 acquires the model name of the self-relevant printer PRT1 from the printer controller 42. According to the concrete procedure, the parent task processing module 23 specifies the IP address ‘IP11’ of the self-relevant printer PRT1 as the receiver IP address and makes an inquiry about the model name of the printer PRT1 by SNMP (Simple Network Management Protocol). The CPU 20 accordingly makes an inquiry to the printer controller 42 via a bus about the model name of the printer PRT1 and receives a response to the inquiry. In this manner, the parent task processing module 23 makes an inquiry about the model name of the self-relevant printer at every power on time. This is because the custom network board CNB is freely attachable to and detachable from various types of printers and may thus be used in parallel in multiple printers of different types.

The memory 30 of the printer PRT1 keeps storage of the distribution destination specification file Fa and the head number file Fb. The following description regards the details of the distribution destination specification file Fa and the head number file Fb.

The distribution destination specification file Fa is used to specify the user's selected printers for the distribution destination printer and the sequence of these selected printers and to set the specification in the printer PRT1. As shown in FIG. 1, the distribution destination specification file Fa includes IP addresses of the user's selected printers for the distribution destination printer with ordinal numbers representing the sequence of these selected printers. The distribution destination specification file Fa is generated and is stored in the memory 30 of the printer PRT1 according to the following procedure.

When the user manipulates a terminal connecting with the network to a non-illustrated www server in the printer PRT1, the www server sends back a homepage for the user's specification of desired printers for the distribution destination printer, to the terminal. The user then specifies desired printers for the distribution destination printer on the homepage. The distribution destination specification file Fa is generated according to the user's specification and is stored in the memory 30 of the printer PRT1.

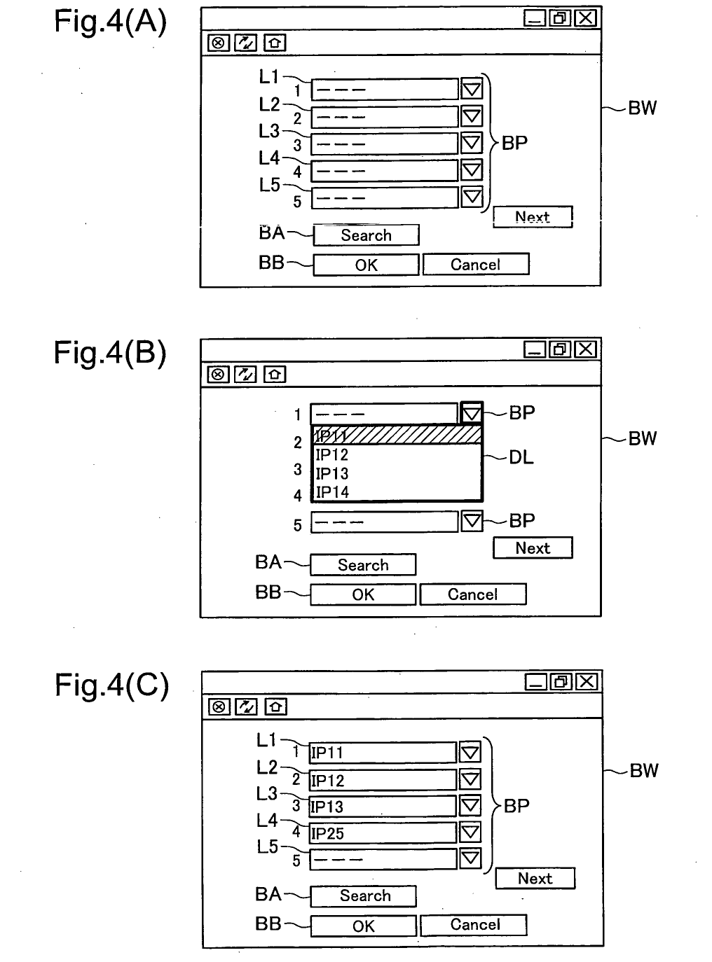

FIG. 4 shows an example of the homepage for the user's specification of desired printers for the distribution destination printer, which is open on a browser window BW of the terminal. FIG. 4(A) shows the initial state of the homepage. FIG. 4(B) shows specification of a first printer on the homepage. FIG. 4(C) shows completed specification of all the user's desired printers on the homepage. This homepage includes IP address entry boxes L1 through L5 for entry of IP addresses of the user's specified printers, as well as several buttons including pulldown buttons BP, a search button BA, and an OK button BB.

In response to the user's click of the search button BA on the homepage in the initial state shown in FIG. 4(A), the parent task processing module 23 utilizes the SNMP to broadcast an inquiry about the model name to the respective devices connected to the local area network LAN1. The parent task processing module 23 then lists the IP addresses allocated to the printers of the identical model with the printer PRT1 among all the responded devices. In this illustrated example, the IP addresses IP11 to IP14 are listed.

The user's click of the pulldown button BP on the side of the IP address entry box L1 opens a dropdown list DL to specify the user's desired printer for the first distribution destination printer as shown in FIG. 4(B). The dropdown list DL includes the listed IP addresses. In response to the user's selection of one IP address allocated to the user's desired printer for the first distribution destination printer, the selected IP address is entered in the IP address entry box L1. In response to the user's selection of another IP address allocated to the user's desired printer for the second distribution destination printer, the selected IP address is entered in the IP address entry box L2. The sequential entries of the IP addresses in the IP address entry boxes automatically specify the sequence of the user's selected printers for the distribution destination printer. All the searched and listed printers may not be selected by the user.

The broadcast inquiry about the model name covers only the local area network LAN1 and is not sent to the printer PRT5 connected to the different local area network LAN2. The printer PRT5 thus naturally does not respond to the inquiry, and the IP address 25 of the printer PRT5 is not included in the dropdown list DL. The user is thus required to directly enter the IP address (IP25) of the printer PRT5 in one IP address entry box, in order to specify the printer PRT5 for the distribution destination printer.

When the user clicks the OK button BB after sequential specification of the IP addresses IP11, IP12, IP13, and IP25 of the user's desired printers, the distribution destination specification file Fa is generated and is stored in the memory 30. The generated distribution destination file Fa has the contents shown in FIG. 1.

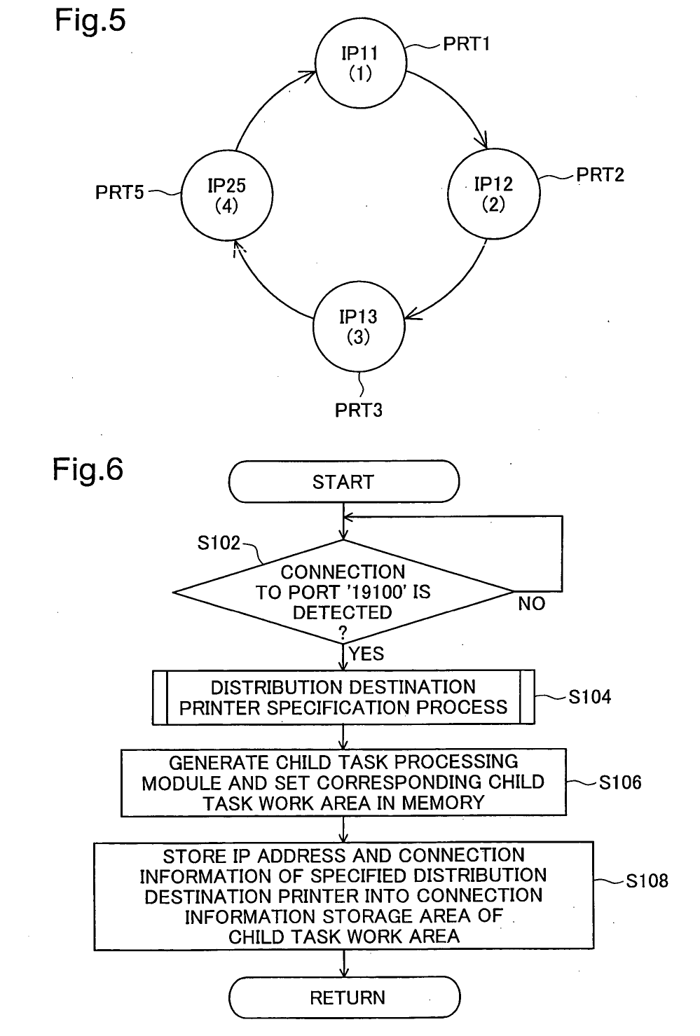

FIG. 5 conceptually shows the sequence of the desired printers for the distribution destination printer specified in the distribution destination specification file Fa. For the clarity of illustration, the IP addresses IP11, IP12, IP13, and IP25 are encircled to represent the corresponding printers having these IP addresses (the printers PRT1 to PRT3 and the printer PRT5). The arrows show the sequence of these desired printers. Each numeral in the parentheses represents the ordinal number of the printer.

In this illustrated example, the printers PRT1, PRT2, PRT3, and PRT5 are specified in this sequence. The respective ordinal numbers 1 to 4 do not represent the preferential order of the desired printers but show the sequential relation of the specified printers shown in FIG. 5. For example, the printer immediately before the printer PRT1 in the sequential relation is the printer PRT5, whereas the printer immediately after the printer PRT1 in the sequential relation is the printer PRT2.

The head number file Fb is used by the parent task processing module 23 to specify one distribution destination printer. One of the ordinal numbers 1 to 4 included in the distribution destination specification file Fa is selected and written in the head number file Fb as shown in FIG. 1. The ordinal number written in the head number file Fb has an initial value ‘1’. This head number is overwritten every when the parent task processing module 23 specifies one distribution destination printer. The procedure of overwriting the head number file Fb will be described in detail later.

The printer PRT1 receives multiple print jobs sent from the client CL and distributes the received print jobs into the specified distribution destination printers for printing under the policy of restricting specification of an identical printer for consecutive distribution of sequential print jobs.

In the distributed printing process, the user confirms that the non-procedural protocol is set to the printing protocol in the printer driver on the client CL and changes the setting of the port number from the general number ‘9100’ to the particular number ‘19100’. In the structure of the embodiment, the port number set to the general number ‘9100’ selects the general printing process, and the port number set to the particular number ‘19100’ selects the distributed printing process.

In response to the user's print command given to the client CL, the application software 13 installed in the client CL sends communication data DT1 including a print job to the printer PRT1 via the non-procedural protocol interpretation module 12 and the TCP/IP interpretation module 11. Prior to the transmission of the communication data DT1, the TCP/IP interpretation module 11 of the client CL sends a connection request with the port number ‘19100’ to the TCP/IP interpretation module 21 of the printer PRT1 to establish a connection between the client CL and the printer PRT1.

On reception of the connection request with the particular port number ‘19100’, the TCP/IP interpretation module 21 of the printer PRT1 notifies the parent task processing module 23 via the non-procedural protocol interpretation module 22A allocated to the port number ‘19100’ of the reception of the connection request with the port number ‘19100’ from the client CL. The TCP/IP interpretation module 21 of the printer PRT1 concurrently sends back a connection response to the TCP/IP interpretation module 11 of the client CL to make a connection between the client CL and the printer PRT1.

FIG. 6 is a flowchart showing a parent task processing routine executed in the printer PRT1.

The parent task processing module 23 first detects a connection to the port ‘19100’ (step S102). In response to detection of such a connection on the basis of the notified connection request, the parent task processing module 23 executes a distribution destination printer specification process (step S104). The distribution destination printer specification process specifies one printer as the distribution destination printer under the policy of restricting consecutive selection of an identical printer as the distribution destination printer. The details of the distribution destination printer specification process will be discussed later. The following description is on the assumption that the printer PRT2 is specified as the distribution destination printer.

After specification of the distribution destination printer, the parent task processing module 23 generates one child task processing module 24A and sets a corresponding child task work area 31A in the memory 30 (step S106).

The parent task processing module 23 stores the IP address IP12 of the printer PRT2 specified as the distribution destination printer, as well as connection information in the connection information storage area 32 of the child task work area 31A (step S108). The connection information is obtained on establishment of the connection between the client CL and the printer PRT1 and includes the IP address IPc and a port number (for example, ‘40000’) of the client CL and the IP address IP11 and the port number ‘19100’ of the printer PRT1.

On completion of the processing at step S108, the parent task processing module 23 goes back to step S102 and repeats the processing routine. In response to reception of another connection request prior to transmission of next communication data DT2 from the client CL, the printer PRT1 newly generates one child task processing module 24B different from the previously generated child task processing module 24A. In this manner, the printer PRT1 generates multiple child task processing modules in response to multiple connection requests.

After establishment of the connection between the client CL and the printer PRT1, the client CL sends the communication data DT1 to the printer PRT1 as mentioned above. The non-procedural protocol interpretation module 12 of the client CL sends communication data including a print job according to the non-procedural printing protocol. The TCP/IP interpretation module 11 of the client CL sets the IP address ‘IP11’ of the printer PRT1 to the receiver IP address of the communication data and specifies the particular number ‘19100’, instead of the general number ‘9800’, as the receiver port number. The communication data DT1 sent from the client CL to the printer PRT1 accordingly include the receiver IP address ‘IP11’ and the receiver port number ‘19100’.

The TCP/IP interpretation module 21 of the printer PRT1 specified by the receiver IP address ‘IP11’ included in the communication data DT1 receives the communication data DT1 and transfers the received communication data DT1 to the non-procedural protocol interpretation module 22A specified by the receiver port number ‘19100’ included in the communication data DT1.

The child task processing module 24A generated by the parent task processing module 23 stands by at the port ‘19100’ and waits for reception of a print job. The non-procedural protocol interpretation module 22A receives the communication data DT1 including print job data and transfers the print job data to the child task processing module 24A standing by at the port ‘19100’. The child task processing module 24A then executes a series of child task processing.

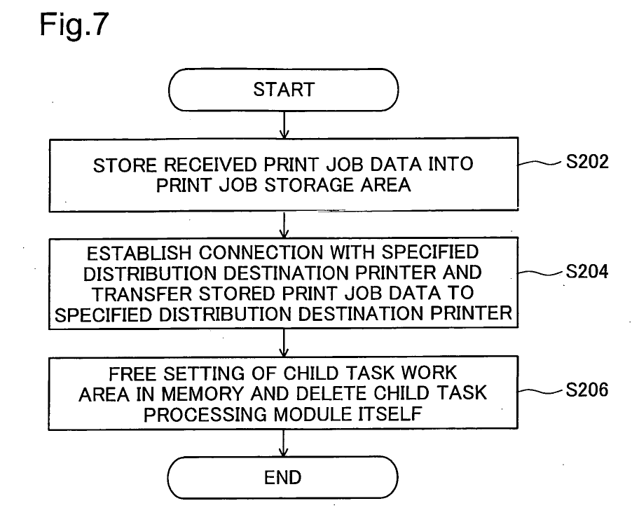

FIG. 7 is a flowchart showing a child task processing routine executed in the printer PRT1. The child task is executed independently by each child task processing module.

The child task processing module 24A first stores the print job data transferred from the non-procedural protocol interpretation module 22A into the print job storage area 33 of the child task work area 31A (step S202).

The child task processing module 24A then reads out the IP address of the specified distribution destination printer and the connection information stored in the connection information storage area 32 by the parent task processing module 23 to establish a connection between the printer PRT1 and the specified distribution destination printer, and transfers the print job data stored in the print job storage area 33 to the specified distribution destination printer (step S204).

According to the concrete procedure, after establishment of the connection between the printer PRT1 and the specified distribution destination printer, the child task processing module 24A sends the stored print job data to the printer PRT2 specified as the distribution destination printer via the non-procedural protocol interpretation module 22B and the TCP/IP interpretation module 21. The non-procedural protocol interpretation module 22B sends the communication data including the print job data according to the non-procedural printing protocol. The TCP/IP interpretation module 21 sets the IP address ‘IP12’ of the printer PRT2 to the receiver IP address of the communication data and specifies the general number ‘9100’ generally allocated to the non-procedural protocol, instead of the received particular number ‘19100’, as the receiver port number. Communication data DT1′ sent from the printer PRT1 to the printer PRT2 accordingly include the receiver IP address ‘IP12’ and the receiver port number ‘9100’.

On transfer of the received print job to the specified distribution destination printer, the child task processing module 24A frees the setting of the corresponding child task work area 31B in the memory 30 and is deleted (step S206).

In a similar manner, another child task processing module 24B transfers print job data, which is included in the communication data DT2 received from the client CL, as communication data DT2′ to the specified next distribution destination printer.

The description regards the details of the distribution destination printer specification process, which is executed by the parent task processing module 23 and is characteristic of the invention.

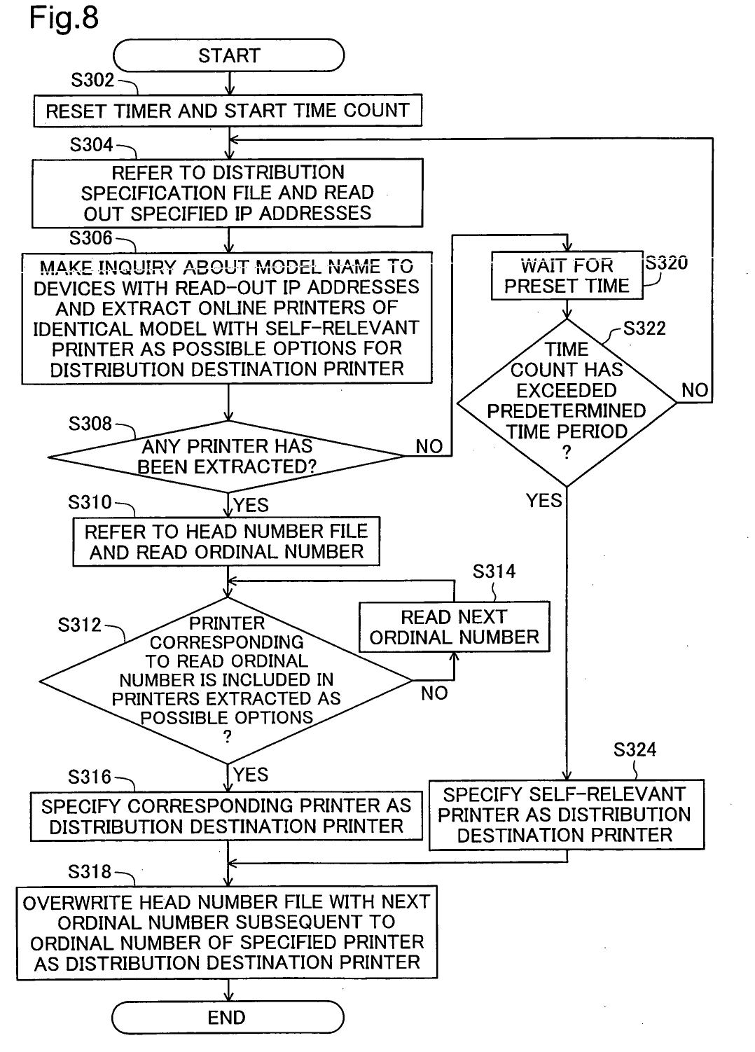

FIG. 8 is a flowchart showing the details of the distribution destination printer specification process executed by the parent task processing module 23.

The parent task processing module 23 first resets a timer (not shown) and starts time count (step S302).

The parent task processing module 23 then refers to the distribution destination specification file Fa stored in the memory 30 and reads out the IP addresses of the printers specified in the distribution destination specification file Fa (step S304).

The parent task processing module 23 utilizes the SNMP to make an inquiry about the model name to the devices of the read-out IP addresses, and extracts online printers of the identical model with the self-relevant printer PRT1 as possible options for the distribution destination printer (step S306). The printers of the identical model with the self-relevant printer PRT1 are extracted as possible options for the distribution destination printer, in order to ensure adequate printing operations at the respective distribution destination printers without any data conversion of print job data in distributed printing. This substantially equalizes the qualities, for example, the resolution and the font, of resulting prints obtained at the respective distribution destination printers.

The parent task processing module 23 has acquired the model name of the self-relevant printer PRT1 at the power on time of the printer PRT1 as described previously. The extraction of the printers of the identical model with the self-relevant printer PRT1 is accordingly based on the acquired model name.

The inquiry about the model name is made to the devices of the IP addresses specified in the distribution destination specification file Fa. After generation of the distribution destination specification file Fa, any of the IP addresses included in the distribution destination specification file Fa may be reallocated to a printer of a different model from the self-relevant printer PRT1 or to even a different device, due to some device replacement. The inquiry is thus made to confirm that the devices of the specified IP addresses are of the identical model with the self-relevant printer PRT1. This inquiry concurrently confirms that the devices of the IP addresses specified in the distribution destination specification file Fa are actually powered on to be online and connectable via the network.

All the printers satisfying the following two conditions are extracted as the possible options for the distribution destination printer:
(1) online; and
(2) identical model with the self-relevant printer PRT1.

The ‘online’ condition (1) excludes offline printers and unavailable printers with some errors, for example, out of paper, out of toner (or out of ink), or paper jam from the possible options for the distribution destination printer. As mentioned previously, each of the printers PRT1 to 5 is capable of receiving another print job data during execution of one print job data. The state of ‘currently not receiving print job data’ or the state of ‘currently not executing print job data’ is thus not required as the condition of extraction.

The self-relevant printer PRT1 is extractable as one possible option for the distribution destination printer, when satisfying the ‘online’ condition (1).

The parent task processing module 23 then determines whether any printer other than the self-relevant printer PRT1 has been extracted as possible options for the distribution destination printer (step S308). In the case of successful extraction, the parent task processing module 23 refers to the head number file Fb stored in the memory 30 and reads out the ordinal number written in the head number file Fb (step S310).

The parent task processing module 23 subsequently determines whether a target printer corresponding to the read ordinal number is included in the extracted printers as the possible options for the distribution destination printer (step S312). In response to an affirmative answer, the target printer is specified as the distribution destination printer (step S316). The ordinal number written in the head number file Fb indicates a target printer to be specified as the distribution destination printer when the target printer is included in the extracted printers as the possible options for the distribution destination printer, that is, when the target printer satisfies the above two conditions ‘online’ and ‘identical model with the self-relevant printer PRT1’.

When the target printer corresponding to the read ordinal number is not included in the extracted printers as the possible options for the distribution destination printer, on the other hand, the parent task processing module 23 reads a next ordinal number subsequent to the ordinal number written in the head number file Fb (step S314) and goes back to step S312 to determine whether a target printer corresponding to the next ordinal number is included in the extracted printers as the possible options for the distribution destination printer. The parent task processing module 23 repeats this series of processing until successful specification of the distribution destination printer.

After specification of the distribution destination printer, the parent task processing module 23 overwrites the head number file Fb with a next ordinal number subsequent to the ordinal number of the specified distribution destination printer (step S318). In a next cycle of the distribution destination printer specification process, when a printer of the next ordinal number subsequent to the ordinal number of the specified distribution destination printer is included in printers extracted as possible options, the parent task processing module 23 specifies the printer of the next ordinal number as the distribution destination printer.

The process of specifying the distribution destination printer is described concretely with reference to some examples.

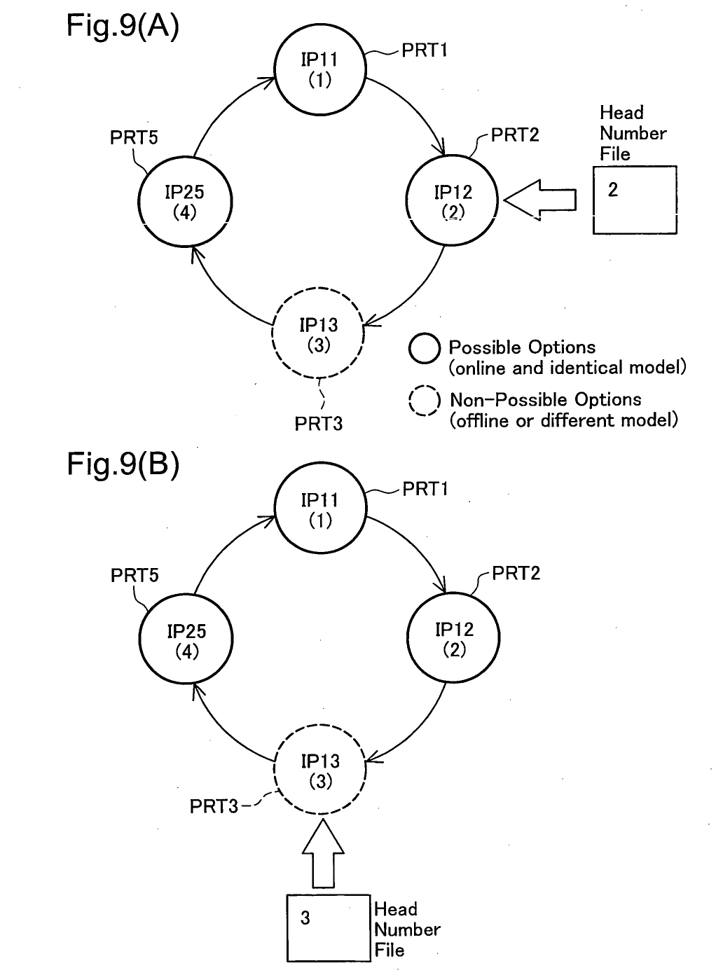

FIG. 9 conceptually shows an example of specification of the distribution destination printers. The state of FIG. 9(A) specifies the distribution destination printer for the print job included in the communication data DT1. The state of FIG. 9(B) specifies the distribution destination printer for the communication data DT2 received after the communication data DT1.

The circles and the arrows in FIG. 9 have the same meanings as those in FIG. 5. The circles of the solid line represent the printers that have been extracted as the possible options for the distribution destination printer, whereas the circles of the broken line represent the printers that have not extracted as the possible options for the distribution destination printer.

In the state of FIG. 9(A) to specify the distribution destination printer for the print job included in the communication data DT1, the parent task processing module 23 extracts the printers PRT1, PRT2, and PRT4 as the possible options for the distribution destination printer and reads an ordinal number ‘2’ written in the head number file Fb. In this case, the printer PRT2 corresponding to the ordinal number ‘2’ is included in the printers extracted as the possible options. The printer PRT2 is thus specified as the distribution destination printer. At step S318, the parent task processing module 23 overwrites the head number file Fb with a next ordinal number ‘3’ subsequent to the ordinal number ‘2’ of the printer PRT2 specified as the distribution destination printer.

In the state of FIG. 9(B) to specify the distribution destination printer for the print job included in the communication data DT2 received after the communication data DT1, the parent task processing module 23 extracts the printers PRT1, PRT2, and PRT4 as the possible options for the distribution destination printer and reads the ordinal number ‘3’ currently written in the head number file Fb. In this case, the printer PRT3 corresponding to the ordinal number ‘3’ is not included in the printers extracted as the possible options. The parent task processing module 23 accordingly reads a next ordinal number ‘4’ subsequent to the ordinal number ‘3’ of the printer PRT3. The printer PRT4 corresponding to the ordinal number ‘4’ is included in the printers extracted as the possible options. The printer PRT4 is thus specified as the distribution destination printer.

The parent task processing module 23 then overwrites the head number file Fb with a next ordinal number ‘1’ subsequent to the ordinal number ‘4’ of the printer PRT4 specified as the distribution destination printer.

On specification of the distribution destination printers in this manner, the corresponding child task processing modules respectively send the print job data included in the communication data DT1 to the specified printer PRT2 and the print job data included in the communication data DT2 to the specified printer PRT4. These specified printers PRT2 and PRT4 then execute printing operations according to the received print job data.

Referring back to the flowchart of FIG. 8, when no printer other than the self-relevant printer PRT1 has been extracted as a possible option for the distribution destination printer at step S308, the parent task processing module 23 makes another inquiry about the model name to the devices with the IP addresses included in the distribution destination specification file Fa and newly extracts possible options for the distribution destination printer. When a next cycle of this specification process is executed in a short time, there is a high possibility that the device of some listed IP address still has some error, for example, out of paper, and is kept offline. This device is thus not extracted again as a possible option for the distribution destination printer.

In the case of failed extraction of any printer other than the self-relevant printer PRT1 as a possible option for the distribution destination printer, after waiting a preset time (for example, 5 seconds) (step S320), the parent task processing module 23 determines whether the time count has exceeded a predetermined time period, for example, 5 minutes (step S322). In response to a negative answer, the parent task processing module 23 goes back to steps S304 and S306 to extract all the printers satisfying the conditions as possible options for the distribution destination printer. The parent task processing module 23 repeats this series of processing until successful extraction of at least one printer other than the self-relevant printer PRT1 as the possible options. The timer continues the time count during the repeated processing. While the series of processing is repeated for the predetermined time period, for example, one unavailable printer with the out-of-paper error may have a supply of paper to be available online and another offline printer may be powered on to be available online. These printers are then extractable as the possible options for the distribution destination printer.

In the case of failed extraction of any printer other than the self-relevant printer PRT1 as a possible option for the distribution destination printer even after elapse of the predetermined time period, the parent task processing module 23 specifies the self-relevant printer PRT1 as the distribution destination printer (step S324). At subsequent step S318, the parent task processing module 23 overwrites the head number file Fb with a next ordinal number ‘2’ subsequent to the ordinal number ‘1’ of the self-relevant printer PRT1.

### A5. Effects of Embodiment

In the printing system of this embodiment described above, the printer PRT1 having the distributed printing control functions overwrites the head number file Fb with a next ordinal number subsequent to the ordinal number of the previously specified distribution destination printer. In a next cycle of the printer specification process, the printer PRT1 determines whether the printer corresponding to the ordinal number currently written in the head number file Fb is included in the printers extracted as the possible options for the distribution destination printer. When the corresponding printer is not included in the extracted possible options, the printer PRT1 sequentially reads out the given ordinal numbers to the last, which is identical with the ordinal number of the previously specified distribution destination printer, and repeats the determination.

The procedure of this embodiment thus effectively lowers the potential that an identical printer is consecutively specified as the distribution destination printer. This arrangement desirably prevents inefficient concentration of print jobs on one particular printer and completes printing in a short time period.

The printer PRT1 extracts the possible options for the distribution destination printer among the printers with the IP addresses included in the distribution destination specification file Fa. Namely the distribution destination specification file Fa informs the printer PRT1 of the user's desired printers for the distribution destination printer.

The printer PRT1 makes an inquiry about the model name to the devices with the specified IP addresses, prior to the final specification of the distribution destination printer. Based on the results of this inquiry, the offline or unavailable printers with some errors, for example, out-of-paper error, and non-printer devices are excluded from the possible options for the distribution destination printer. This arrangement effectively avoids selection of such printers and devices for the distribution destination printer, thus completing printing in a short time period.

### B. Second Embodiment

The technique of the first embodiment uses the identical printing protocol (non-procedural protocol) but different port numbers (the general number ‘9100’ and the particular number ‘19100’) in the process of sending print jobs from the client CL to the printer PRT1 having the distributed printing control functions and in the process of sending the print jobs from the printer PRT1 to the specified distribution destination printers to achieve distributed printing. The technique of a second embodiment uses different printing protocols in the process of sending print jobs from the client CL to the printer PRT1 having the distributed printing control functions and in the process of sending the print jobs from the printer PRT1 to the specified distribution destination printers to achieve distributed printing.

### B1. Structure of Printer

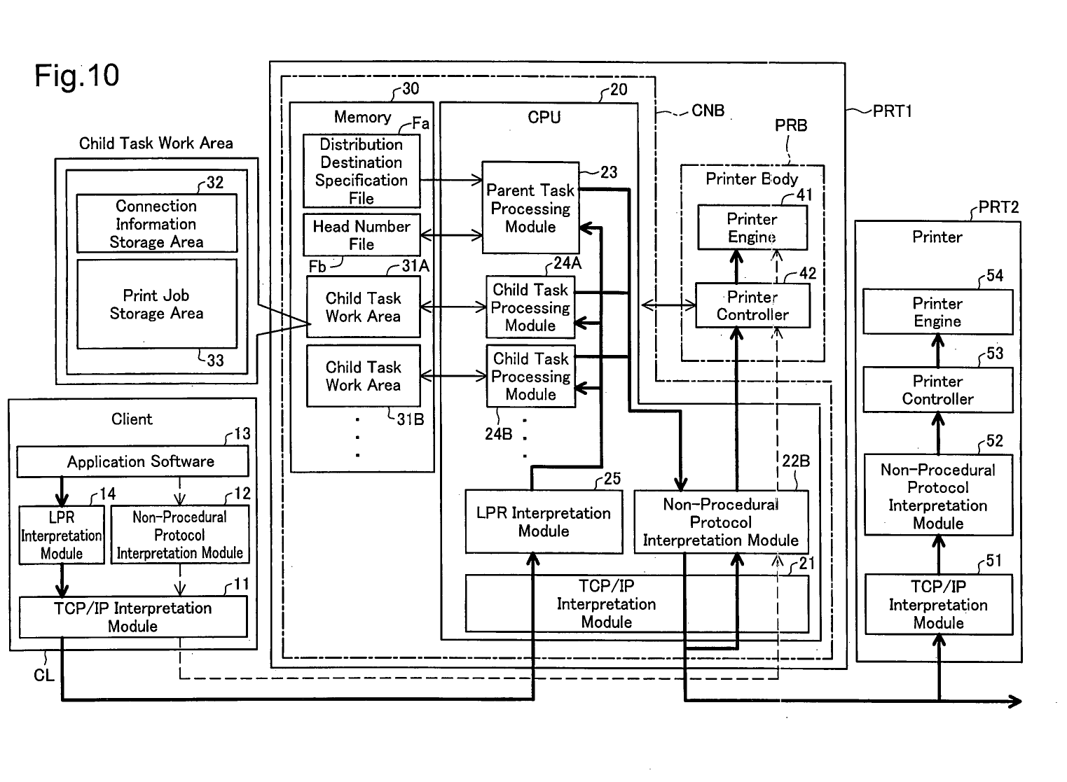

FIG. 10 mainly shows the structure of the printer PRT1 in the second embodiment of the invention. The structure of the printer PRT1 of the second embodiment shown in FIG. 10 is similar to the structure of the printer PRT1 of the first embodiment shown in FIG. 3, except that the non-procedural protocol interpretation module 22A is replaced by an LPR interpretation module 25 (the non-procedural protocol interpretation module 22B is kept unchanged) and that the client CL correspondingly has an LPR interpretation module 14.

In the structure of FIG. 10, both the LPR interpretation modules 25 and 14 interpret a printing protocol LPR (Line Printer daemon protocol).

### B2. General Printing Process

A general printing process is described briefly, prior to description of a distributed printing process. In an example of the general printing process, a print job is sent from the client CL to the printer PRT1 and is executed by only the printer PRT1. In this case, the print job is transferred along a route shown by the dotted arrows in FIG. 10. The printing protocol is set to the non-procedural protocol in a printer driver (not shown) of the client CL.

In response to the user's print command given to the client CL, the application software 13 installed in the client CL sends a print job via the non-procedural protocol interpretation module 12 and the TCP/IP interpretation module 11 to the printer PRT1. The non-procedural protocol interpretation module 12 sends communication data including the print job according to the non-procedural printing protocol. The TCP/IP interpretation module 11 specifies ‘IP11’ allocated to the printer PRT1 as the receiver IP address of the communication data.

The TCP/IP interpretation module 21 of the printer PRT1 specified by the receiver IP address ‘IP11’ included in the communication data receives the communication data and transfers the received communication data to the non-procedural protocol interpretation module 22B. The non-procedural protocol interpretation module 22B receives the communication data including the print job and transfers the print job to the printer controller 42 according to the non-procedural protocol. The printer controller 42 controls the printer engine 41 to perform a printing operation specified by the received print job.

### B3. Distributed Printing Process

The distributed printing process executed in the second embodiment is described briefly. In order to implement distributed printing, the user changes the setting of the printing protocol from the non-procedural protocol to the LPR in the printer driver of the client CL. The technique of the second embodiment changes over the setting of the printing protocol to selectively execute the general printing process according to the non-procedural protocol and the distributed printing process according to the LPR.

In response to the user's print command given to the client CL, the application software 13 installed in the client CL sends a print job to the printer PRT1 via the LPR interpretation module 14 and the TCP/IP interpretation module 11. Prior to the transmission of the print job, the TCP/IP interpretation module 11 of the client CL sends a connection request to the TCP/IP interpretation module 21 of the printer PRT1 to establish a connection between the client CL and the printer PRT1.

On reception of the connection request, the TCP/IP interpretation module 21 of the printer PRT1 notifies the parent task processing module 23 via the LPR interpretation module 25 of the reception of the connection request from the client CL. The TCP/IP interpretation module 21 of the printer PRT1 concurrently sends back a connection response to the TCP/IP interpretation module 11 of the client CL to make a connection between the client CL and the printer PRT1.

In the structure of the second embodiment, the parent task processing module 23 notified of the received connection request specifies the distribution destination printer for the print job and generates a child task processing module in the same manner as the first embodiment. This series of processing is thus not specifically described here. For example, it is assumed that the parent task processing module 23 specifies the printer PRT2 as the distribution destination printer and generates a child task processing module 24A.

The generated child task processing module 24A sends the print job stored in the print job storage area 33 of the child task work area 31A to the printer PRT2 not via the LPR interpretation module 25 but via the non-procedural protocol interpretation module 22B and the TCP/IP interpretation module 21. The non-procedural protocol interpretation module 22B sends communication data including the print job according to the non-procedural printing protocol. The TCP/IP interpretation module 21 specifies the IP address ‘IP12’ of the printer PRT2 as the receiver IP address of the communication data.

As shown in FIG. 10, the TCP/IP interpretation module 51 of the distribution destination printer PRT2 specified by the receiver IP address ‘IP12’ included in the communication data receives the communication data and transfers the received communication data to the non-procedural protocol interpretation module 52. The non-procedural protocol interpretation module 52 receives the communication data including the print job and transfers the print job to the printer controller 53 according to the non-procedural protocol. The printer controller 53 controls the printer engine 54 to perform a printing operation specified by the received print job.

The PRT2 specified as the distribution destination printer thus implements the required printing operation. The other series of processing are identical with those of the first embodiment and are not specifically described here.

### B4. Effects of Embodiment

In the printing system of the second embodiment described above, like the first embodiment, the printer PRT1 having the distributed printing control functions overwrites the head number file Fb with a next ordinal number subsequent to the ordinal number of the previously specified distribution destination printer. In a next cycle of the printer specification process, the printer PRT1 determines whether the printer corresponding to the ordinal number currently written in the head number file Fb is included in the printers extracted as the possible options for the distribution destination printer. When the corresponding printer is not included in the extracted possible options, the printer PRT1 sequentially reads out the given ordinal numbers to the last, which is identical with the ordinal number of the previously specified distribution destination printer, and repeats the determination.

The procedure of this embodiment thus effectively lowers the potential that an identical printer is consecutively specified as the distribution destination printer. This arrangement desirably prevents inefficient concentration of print jobs on one particular printer and completes printing in a short time period.

Like the first embodiment, the printer PRT1 extracts the possible options for the distribution destination printer among the printers with the IP addresses included in the distribution destination specification file Fa. Namely the distribution destination specification file Fa informs the printer PRT1 of the user's desired printers for the distribution destination printer.

Like the first embodiment, the printer PRT1 makes an inquiry about the model name to the devices with the specified IP addresses, prior to the final specification of the distribution destination printer. Based on the results of this inquiry, the offline or unavailable printers with some errors, for example, out-of-paper error, and non-printer devices are excluded from the possible options for the distribution destination printer. This arrangement effectively avoids selection of such printers and devices for the distribution destination printer, thus completing printing in a short time period.

### C. Modifications

The embodiments and their applications discussed above are to be considered in all aspects as illustrative and not restrictive. There may be many modifications, changes, and alterations without departing from the scope or spirit of the main characteristics of the present invention. Some examples of possible modification are given below.

### C1. Modified Example 1

In the first and the second embodiments discussed above, the head number file Fb includes a next ordinal number subsequent to the ordinal number of the previously specified distribution destination printer. The head number file may otherwise include the ordinal number of the previously specified distribution destination printer. In this modified structure, the parent task processing module 23 determines whether the printers extracted as the possible options for the distribution destination printer include a printer corresponding to a next ordinal number subsequent to the ordinal number written in the head number file Fb at step S312 in the flowchart of FIG. 8.

As long as the parent task processing module 23 can check the previously specified distribution destination printer, the ordinal number written in the head number file may be replaced by any other suitable piece of information for identifying the previously specified distribution destination printer, for example, the IP address allocated to the previously specified distribution destination printer.

### C2. Modified Example 2

In the first and the second embodiments discussed above, the head number file Fb including a next ordinal number subsequent to the ordinal number of the previously specified distribution destination printer is provided separately from the distribution destination specification file Fa. One possible modification may not separately provide the head number file but may cause the distribution destination specification file to include a next ordinal number subsequent to the ordinal number of the previously specified distribution destination printer. For example, the distribution destination specification file may be rewritten to have the IP address of a printer with a next ordinal number subsequent to the ordinal number of the previously specified distribution destination printer, as the first IP address.

### C3. Modified Example 3

In the first and the second embodiments discussed above, the two conditions ‘online’ and ‘identical model with the printer having the distributed printing control functions’ are set for extraction of the possible options for the distribution destination printer. Other conditions, for example, ‘not currently executing a print job’ and ‘not having storage of print job data of or over a preset volume’ may be set in addition to these two conditions. This modified arrangement enables selection of a printer having the high potential for starting execution of a print job at the earlier timing, thus completing printing in a shorter time period.

### C4. Modified Example 4

In the first and the second embodiments discussed above, the printing system distributes multiple print jobs to multiple printers. The technique of the invention is also applicable to the printing system that distributes one print job to multiple printers. For example, in reception of one print job to print multiple copies, the printing system generates multiple print job divisions that respectively print one copy, and distributes the print job divisions to multiple printers. This copy distribution system specifies multiple printers as the receivers of the print job divisions based on the distribution destination specification file and the head number file and sequentially sends the print job divisions to the specified multiple receiver printers.

### C5. Modified Example 5

In the first and the second embodiments discussed above, as shown in the flowchart of FIG. 7, the child task processing module stores received print job data in the print job storage area, prior to establishment of a connection with the specified distribution destination printer, and transfers the stored print job data. In one possible modification, the child task processing module may establish a connection with the specified distribution destination printer prior to reception of a print job and immediately transfer the received print job to the specified distribution destination printer without storage.

This arrangement desirably reduces the storage capacity of the print job storage area and thereby the total memory capacity.

### C6. Modified Example 6

The printing system of the first embodiment adopts the non-procedural protocol for the printing protocol. The non-procedural protocol may be replaced by another printing protocol that is capable of changing the port number, for example, LPR, IPP (Internet Printing Protocol), FTP (File Transfer Protocol), SMB (Server Message Black), or AppleTalk. The printing system of the second embodiment adopts the combination of the LPR and the non-procedural protocol as the printing protocols. Any other combination of different printing protocols may be used for the same purpose.

### C7. Modified Example 7

In the first and the second embodiments discussed above, distributed printing is attained by adopting different port numbers or by adopting different printing protocols in the process of sending print jobs from the client to the printer PRT1 having the distributed printing control functions and in the process of sending the print jobs from the printer PRT1 to the specified distribution destination printers. Distributed printing may otherwise be attained by adopting different print commands to be included in the print job data or by adopting different commands (including an identical command with different attributes, for example, different command options) to be used on the printing protocol.

### C8. Modified Example 8

In the first and the second embodiments discussed above, a fixed IP address is allocated to each device connected to the LAN. The IP address may be allocated dynamically to each device by a DHCP (Dynamic Host Configuration Protocol) server. Allocation of a fixed IP address to the printer having the distributed printing control functions (printer PRT1) is desirable, however, in the procedure of specifying each printer by its IP address and selectively using the general port number ‘9100’ and the particular port number ‘19100’ as discussed in the first embodiment.

### C9. Modified Example 9

In the first and the second embodiments discussed above, the IP addresses are used for specification of the receiver, extraction of the possible options for the distribution destination printer, and specification of the user's desired printers for the distribution destination in the distribution destination specification file. The IP address may be replaced by another piece of information specifying or identifying each printer, for example, a MAC (Media Access Control) address or a Windows (registered trademark) printer name. This modification ensures identification of each printer even in the case of dynamic allocation of IP addresses by the DHCP.

### C10. Modified Example 10

In the first and the second embodiments discussed above, the distribution destination specification file specifies IP addresses of the user's desired printers for the distribution destination. This is, however, not restrictive at all. The distribution destination specification file may specify an allowable range of IP address for retrieval of the user's desired printers for the distribution destination.

### C11. Modified Example 11

In the first and the second embodiments discussed above, the custom network board CNB acquires the model name of the self-relevant printer PRT1 on every power on time of the printer PRT1. This is, however, not essential. The model name of the self-relevant printer PRT1 may be acquired at any timing prior to the processing of step S306 (extraction of online printers of the identical model with the self-relevant printer) in the distribution destination printer specification process of FIG. 8. In one modified example, the model name of the self-relevant printer PRT1 may be acquired immediately before the processing of step S306.

### C12. Modified Example 12

In the first and the second embodiments discussed above, the distributed printing control apparatus is constructed as the custom network board CNB built in the printer PRT1. The technique of the invention is, however, not restricted to this structure. The distributed printing control apparatus may be provided separately from the printer PRT1 and may be connected with the printer PRT1 by wire connection, such as USB connection, IEEE1394 bus connection, parallel connection, or serial connection or wireless connection, such as Bluetooth connection, wireless LAN connection, or infrared connection.

1. A distributed printing control apparatus that distributes multiple print jobs sent via a network to at least two printing devices among multiple printing devices connected to the network, the distributed printing control apparatus comprising:
a storage module that stores identification information for identifying at least a previous distribution destination printing device among the multiple printing devices; and
a control module,
wherein the control module, on reception of a print job sent under a preset condition, specifies a current distribution destination printing device based on the identification information, among residual printing devices other than the previous distribution destination printing device, sends the received print job to the specified current distribution destination printing device, and stores information for identifying the specified current distribution destination printing device as the identification information into the storage module.

2. A distributed printing control apparatus in accordance with claim 1, wherein the storage module stores sequence information representing a predetermined sequence of the multiple printing devices, and
the control module selects a printing device with a next ordinal number subsequent to an ordinal number of the previous distribution destination printing device, based on the identification information and the sequence information, and specifies the selected printing device as the current distribution destination printing device.

3. A distributed printing control apparatus in accordance with claim 1, wherein the control module extracts at least online printing devices as possible options for a distribution destination printing device among the multiple printing devices, and specifies the current distribution destination printing device among the extracted possible options other than the previous distribution destination printing device, based on the identification information.

4. A distributed printing control apparatus in accordance with claim 1, wherein the storage module stores sequence information representing a predetermined sequence of the multiple printing devices, and
the control module extracts at least online printing devices as possible options for a distribution destination printing device among the multiple printing devices, refers to the identification information and the sequence information to sequentially retrieve a printing device that has a next ordinal number subsequent to an ordinal number of the previous distribution destination printing device and is included in the extracted possible options, and specifies a first retrieved printing device as the current distribution destination printing device.

5. A distributed printing control apparatus in accordance with claim 1, wherein the print job sent under the preset condition includes at least one of a print job sent with a specific port number, a print job sent in a specific printing protocol, a print job sent by a specific command on a printing protocol, and a print job sent in a format including a specific print command.

6. A distributed printing control apparatus in accordance with claim 1, wherein the print job sent under the preset condition is a print job sent with a specific port number, and
the control module sends the print job with a different port number from the particular port number to the current distribution destination printing device.

7. A distributed printing control apparatus in accordance with claim 1, wherein the print job sent under the preset condition is a print job sent in a specific printing protocol, and
the control module sends the print job in a different printing protocol from the specific printing protocol to the current distribution destination printing device.

8. A distributed printing control apparatus in accordance with claim 1, wherein the print job sent under the preset condition is a print job sent by a specific command on a printing protocol, and
the control module sends the print job by a different command on the printing protocol from the specific command to the current distribution destination printing device.

9. A distributed printing control apparatus in accordance with claim 1, wherein the print job sent under the preset condition is a print job sent in a format including a specific print command, and
the control module sends the print job including a different print command from the specific print command to the current distribution destination printing device.

10. A distributed printing control apparatus in accordance with claim 1, the distributed printing control apparatus being built in or being connected to at least one particular printing device among the multiple printing devices connected to the network.

11. A distributed printing control apparatus in accordance with claim 10, wherein the control module is allowed to specify the particular printing device as the current distribution destination printing device.

12. A distributed printing control apparatus in accordance with claim 10, wherein the control device extracts printing devices of an identical model with the particular printing device among the multiple printing devices and specifies the current distribution destination printing device among the extracted printing devices of the identical model.

13. A distributed printing control apparatus in accordance with claim 12, wherein the storage module stores a distribution destination specification file, and
the control module refers to contents of the distribution destination specification file and extracts the printing devices of the identical model with the particular printing device.

14. A printing device connected to a network, the printing device including a built-in distributed printing control apparatus in accordance with claim 1.

15. A print job distribution method that distributes multiple print jobs sent via a network to at least two printing devices among multiple printing devices connected to the network, the print job distribution method comprising the steps of:
(a) storing identification information for identifying at least a previous distribution destination printing device among the multiple printing devices;
(b) receiving communication data including a print job;
(c) on reception of the communication data sent under a preset condition, specifying a current distribution destination printing device based on the identification information, among residual printing devices other than the previous distribution destination printing device;
(d) sending the received print job to the current distribution destination printing device specified in the step (c); and
(e) storing information for identifying the specified current distribution destination printing device as the identification information.

16. A computer program product that is installed in a distributed printing control apparatus and causes the distributed printing control apparatus to distribute multiple print jobs sent via a network to at least two printing devices among multiple printing devices connected to the network,
the computer program product comprising:
a first program code of storing identification information for identifying at least a previous distribution destination printing device among the multiple printing devices in a storage module included in the distributed printing control apparatus;
a second program code of receiving communication data including a print job;
a third program code of, on reception of the communication data sent under a preset condition, specifying a current distribution destination printing device based on the identification information, among residual printing devices other than the previous distribution destination printing device;
a fourth program code of sending the received print job to the specified current distribution destination printing device;
a fifth program code of storing information for identifying the specified current distribution destination printing device as the identification information in the storage module; and
a computer readable medium that stores the first to fifth program codes.
